(19) United States
(12) Patent Application Publication
(10) Pub. No.: US 2005/0251812 A1
(43) Pub. Date: Nov. 10, 2005

(54) Data conversion system, method, and apparatus

(75) Inventor: Jerry Glade Hayward, American Fork, UT (US)

Correspondence Address: Starkweather and Associates, Suite 200, 9035 South 1300 East, Sandy, UT, 84094, US

(73) Assignee: Convertabase, Inc.

(21) Appl. No.: 11/115,898

(22) Filed: Apr. 27, 2005

Related U.S. Application Data
(60) Provisional application No. 60/565,738, filed on Apr. 27, 2004.

(51) Int. Cl. G06F 13/00

(52) U.S. Cl. 719/328

(57) ABSTRACT

A data conversion system, method, apparatus, and article of manufacture for applying source data a data target in a computing environment. There may be an extraction module for extracting source data and a conversion module for performing a data conversion process. The data conversion process is graphically configurable; stored and streamed in machine language; and includes integration objects, organized in a drag and drop hierarchical structure, including subordinate integration objects, wherein a property of an integration object may be set at a run time. There is a documentation generation module configured to display data mapping. The extraction module handles large records, parses records into sets in a single pass, permits visual analysis of source data, includes parse objects, permits creation of parse objects by click and drag, and creates key fields at run time.

### BACKGROUND OF THE INVENTION

This application claims priority to Provisional Patent Application No. 60/565,738 filed on Apr. 27, 2004, by Jerry Glade Hayward.

### FIELD OF THE INVENTION

The present invention relates to data conversion systems, specifically to powerful, fast, and easily modified data conversion systems, methods, and apparatus.

### DESCRIPTION OF THE RELATED ART

Modern computer systems vary in their design and architecture, with many different models available to achieve the desired combinations of speed, power and efficiency for any given computer environment. This multitude of different computing environments allows a consumer to select the right computer for a particular job. For instance, an engineering firm might need a computer aided design station, which necessitates a very powerful, fast computer, using the newest and most powerful operating system. Meanwhile, a home user might simply want to connect to the Internet to send and receive email, which does not require the expense of a fast computer, nor the most current operating system. Further, computer professionals have the capability to create proprietary computer devices, structures and systems that may be unique and may be uniquely adapted to a particular user or user set. Thus, the proliferation of different computing environments has been beneficial.

Further, as technology rapidly advances, new devices, structures, and systems are developed and enterprises must make decisions as to when and what to adopt. Therefore, the variability of computer devices, structures, and systems is increased, as each enterprise must look to its own position and needs. Also, as an enterprise may acquire or merge with other enterprises, there may be collected a great variety of computing systems, including many diverse databases. Therefore there may be many reasons for an enterprise to find itself using a variety of systems of varying age and compatibility.

However, there are drawbacks to this multitude of computer systems. Because each computer system, including the operating system, may be designed differently, the way that data is actually stored on each computer system may be different. For instance, a set of data stored by a Cobol program looks very different from the same data stored by Oracle. Further, legacy systems (systems that continue to be used despite poor performance/compatibility with modern systems because of a prohibitive cost/time of redesigning/replacing) may be difficult to work with due to varying standards and/or inconvenient methods of storing data. Therefore, it becomes difficult to synchronize/port data between different computer systems.

Data is generally stored as a series of bytes, words, or double words, depending on the format of the medium holding the data and any format choices made by a storage program. Storage formats vary greatly as any format imaginable may be used. Where data must be transferred from a first format to a second format, it must first be transformed into a format appropriate to the second format. Therefore data is converted, usually by a data conversion program that is “hard-coded,” meaning it has been written expressly to make such a specific conversion.

However, where the data format of the storage medium changes, the “hard-coded” data conversion program must also be changed or rewritten to deal with the new changes. For instance, if the data is the output of a database, and the database is changed to add additional data elements, the “hard-coded” data conversion program must be modified to comprehend and properly convert these new data elements. This process of rewriting and modifying data conversion programs can be tedious, expensive, and time consuming, as the data conversion program must be modified to comprehend the new data format(s) and element(s) and to know how to properly convert the data elements into the correct formats. Maintenance expenses for such proprietary code can be very high. Further, such “hard-coded” programs are useless for any purpose except for that which they have been written. Therefore, different data conversion needs must be met independently and without benefits from previous solutions.

There are data conversion tools configured to automate portions of a data conversion process and configured to be portable across different needs. However, most of these tools use proprietary scripting languages that are interpreted. This results in a slow execution. When handling very large conversions, using the tools instead of hard-coding may result in extra days of downtime processing that may result in downtime costs in the millions of dollars.

Further, the tools may be unable to handle more complex conversions. For example, the tools may be unable to handle very large flat files, or may be incompatible with a custom designed or uncommon database. Also, the tools may be insufficiently powerful and adaptable to convert data to an ideal state as would be desired by an enterprise. Still further, enterprises are required to purchase licenses to the tools for several hundred thousand dollars with maintenance costs typically starting in the tens of thousands of dollars.

For dissimilar computers that are connected by client-server architecture, modifying data conversion programs is especially tedious and time consuming. Many networks have “client-server” architectures that allow many clients to connect to one or more servers. Such architecture brings many benefits, such as centralized control, enhanced interconnectivity, increased flexibility and more user empowerment. Further, because servers are typically much faster, more powerful, and have greater storage space than clients, servers tend to outperform clients, especially when using programs that involve complex calculations or tremendous amounts of data. However, the above listed benefits come at a cost of increased need and complexity of data conversion. Each program, operating system, hardware device, and storage system included within the “client-server” architecture also typically requires some form of data conversion to properly meld with the entire system. As server systems may become quite complex, the data conversion needs and complexities may increase exponentially. Further, as the user base increases, there is an exponential increase in the likelihood over time that user needs will change and necessitate changes in data format or data types.

For example, having airline ticket information stored on a server allows ticketing agencies around the world to determine which seats are open for which flights. These agencies may all be using very different computer systems, but must all be capable of interpreting the data stored and managed by the server. Therefore, when the client (ticketing agency) calls a server (or Application Programming Interface, or API), the server or API will typically return a set of values.

For instance, if the program is returning a list of available seats on an airline flight, the number of seats can vary from zero (the plane is fully booked) to the capacity of the plane (there have been no seats sold). This may be even more complex where the seats are divided into categories such as isle or window seats, first and second-class seats, the type of dinners available, etc. The data conversion program must understand these varying data types and be able to interpret between the client and server. This may be complicated further wherein a component of the system may add security to the data, such as encryption or data boundaries (extraneous data at an end of a data set used to ensure an entire data set is transferred).

When the data format changes, for example adding a new class of seats, a new category such as laptop enabled seats, seats close to emergency exits, special needs seats, etc., then the “hard-coded” data conversion program must be modified to include the new categories. Thus as an enterprise may develop new strategies, needs, equipment, etc., these may have an impact on the data used by the enterprise. Adapting “hard-coded” data conversion programs to these changes can be very costly and complex.

These costs and complexities may be even more pronounced where an enterprise, such as an airline, may merge with another enterprise using a substantially different computing system and set of databases. These costs may be pronounced even further if there are legacy computing systems and sets of data that are difficult to use, such as where the data is stored as a very large flat file of an unknown format or is stored on a mainframe.

What is needed is a data conversion system capable of efficiently converting data from a wide variety of computing systems including mainframes and flat files. Further there is a need for a data conversion system that is adapted for quick and easy modifications, thereby being portable between enterprises.

### SUMMARY OF THE INVENTION

The present invention has been developed in response to the present state of the art, and in particular, in response to the problems and needs in the art that have not yet been fully solved by currently available data conversion programs. Accordingly, the present invention has been developed to provide a powerful and easily modified data conversion system.

There may be a data conversion system, method, apparatus, and/or article of manufacture for applying source data from a data source to a data target in a computing environment. In one embodiment, the system or apparatus may include an extraction module and a conversion module. The extraction module may be configured to extract source data from the data source, thereby forming extracted data. The conversion module may be configured to utilize the extracted data and perform a data conversion process upon the extracted data, thereby forming converted data that is adapted to the data target.

In another embodiment, the data conversion process may be graphically configurable and is stored and streamed in machine language, which advantageously significantly enhances efficiency and speed of configuring and performing a conversion. The data conversion process may also include integration objects configured to perform conversion steps. The integration objects may also be organized in a drag and drop hierarchical structure defining an order of execution. More, a first integration object may be subordinate to a second integration object during a run time. Further, it may be that a property of an integration object may be set at a run time. Therefore, there may be an embodiment that may have enhanced configurability, thereby handling a wide variety of conversion and conversion type tasks.

In a still another embodiment, a documentation generation module may be configured to generate documentation for conversions from machine code. Therefore, there may be an embodiment that may couple configuration with documentation, thereby providing updated and consistently correct documentation on a conversion.

In a still yet another embodiment, there may be a visual output module configured to create a visually organized output from data selected from the group consisting of extracted data and converted data.

In a yet another embodiment, there may be a storage module configured to store definition and executable code.

In an additional embodiment, the extraction module may have no limit to data record size other than a limit from a Standard C pointer.

In another additional embodiment, the extraction module may be configured to parse a single record into several sets of extraction data in a single pass.

In a still another additional embodiment, the extraction module may be configured to permit visual analysis of source data. Therefore, a user may be able to evaluate properties of source data.

Looking to a yet another embodiment, the extraction module may include parse objects.

In another embodiment, the extraction module may be configured to permit a user to create an object defining data to be extracted from the file by clicking and dragging.

There may be another embodiment, wherein the extraction module may be configured with an ability to create key fields at a run time.

There may be a method for converting data from a data source to a data target in a computing environment. The method may include accessing data from the data source, converting the accessed data to a form usable by the data target by using a data conversion process streamed in machine code to a processor, wherein the data conversion process is graphically configurable, and storing the converted data in association with the data target.

There may be a method for integrating data from a data source into a data target in a computing environment. The method may include accessing data from a data target in real time or near real-time. The method may include keeping track of what data is new since the last integration method was performed. The method may include converting data from the data source format to the data target format. The method may include cleaning the data. The method may include inserting the data into the data target.

There may be an article of manufacture comprising a program storage medium readable by a processor and embodying one or more instructions executable by the processor to perform a method for applying data from a data source to a data target. The method may include accessing data from the data source, converting the accessed data to a form usable by the data target by using a data conversion process streamed in machine code to a processor, wherein the data conversion process is graphically configurable, and storing the converted data in association with the data target.

There may be an apparatus for applying source data from a data source to a data target in a computing environment. The apparatus may include an extraction unit, a conversion unit, a cleaning unit, and one or more wizard units.

There may be a data conversion system for applying source data from a data source to a data target in a computing environment. The system may include a means for extracting data from a data source. There may be a means for converting data from a data source format to a data target format. There may be a means for cleansing data to more appropriately apply to a data target. There may be means for inserting data into a target.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating an exemplary client/server system;

FIG. 2 is a schematic block diagram illustrating data conversion according to one embodiment of the invention;

FIG. 3 is a schematic block diagram illustrating a data conversion system extracting from multiple sources according to one embodiment of the invention;

FIG. 4 illustrates a flow chart displaying a data conversion configuration method according to one embodiment of the invention;

FIG. 5 illustrates a flow chart displaying data conversion according to one embodiment of the invention;

FIGS. 6-7 illustrate a detailed flow chart displaying a data conversion method according to one embodiment of the invention;

FIG. 8 illustrates a control structure for a data conversion system according to one embodiment of the invention;

FIGS. 9-10 show an exemplary screenshot of a Data Duplicator module according to one embodiment of the invention;

FIGS. 11-13 show an exemplary screenshot of a Data Parse module according to one embodiment of the invention; and

FIG. 14 shows an exemplary screenshot of a Data Cleanse module according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

The figures include schematic block diagrams and flow chart diagrams that illustrate in more detail preferred embodiments of the present invention. The schematic block diagrams illustrate certain embodiments of modules for performing various functions of the present invention. In general, the represented modules include therein executable and operational data for operation within a computer system or computing environment in accordance with the present invention.

As used herein, the terms, instruction set, or executable data, is intended to include any type of computer instructions and computer executable code that may be located within a memory device and/or transmitted as electronic signals over a system bus or network. An identified module of executable code may, for instance, comprise one or more physical or logical blocks of computer instructions that may, for instance, be organized as an object, procedure, or function. Nevertheless, the executables of an identified module need not be located together, but may comprise disparate instructions stored in different locations that together comprise the module and achieve the purpose stated for the module. Indeed, an executable may be a single instruction, or many instructions, and may even be distributed over several different code segments, among different programs, and/or across several devices.

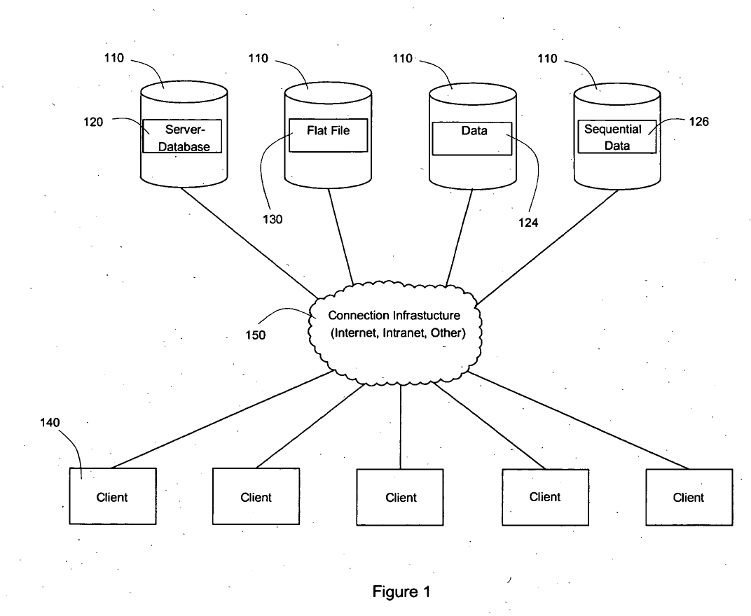

FIG. 1 is a schematic block diagram illustrating an exemplary client/server system. There may be a server 110 or multiple servers, or other media 110 such as storage media, programs, websites, etc., which may be functionally connected 150. The server 110 may hold information such as, but not limited to, in the form of a database 120, flat file 130, data 124, and/or sequential data 126. There may be a database 120, flat file 130, data 124, and/or sequential data 126 stored in other than a server. For example, sequential data 126 may be a feed coming from a program. There may be a client 140 or multiple clients 140 that may be functionally connected to the server 110. Connectivity 150 among servers 110 and clients 140 may be by any known means for communicative connectivity between computer devices, such as but not limited to intranet, internet, and/or direct connections.

In operation, a server may contain and/or manage data. The data may be in the form of a database 120 or a flat file 130. A database 120 or flat file 130 may be spread over several servers 110. Further, a server 110 that may manage the data may be different from a server 110 that stores the data. A user may have access to the data through a client 140. Thereby a user may add data, remove data, and/or otherwise manipulate data.

There may be more than one set of data. There may be more than one set of servers 110 and clients 140. There may be a first set of data having a first data scheme and a second set of data having a second scheme. The first and second sets of data may be on the same or different servers 110 and that may be accessible by the same or different clients 140. There may be reason to combine the first set of data with the second set of data. A desirable result of such combination may be that either set be converted to the scheme of the other or to a third scheme and inserted therein. Such a conversion may be managed by a server 110 or by a client 140. Such a conversion may take place over connectivity 150 such as an internet or intranet or other connection between the pertinent devices, or may take place entirely within a computing device such as a single server.

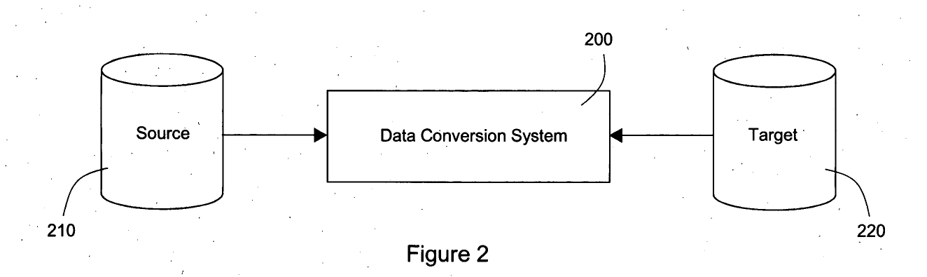

Turning to FIG. 2, there is a schematic block diagram illustrating data conversion according to one embodiment of the invention. There may be a source 210 having source data such as a database 120 (see FIG. 1) or flat file 130 (see FIG. 1) stored on a server 110 (see FIG. 1). The source 210 may contain data in a source scheme. There may be a target 220 that may be a database 120 or a flat file 130. The target 220 may only exist as a desired result. For example, it may be desired to wholly create a standardized database 120 from a flat file 130. The target 220 may contain target data in a target scheme that may differ from the source scheme.

For example, the source 210 may be a flat file 130 stored on a first server in a unique and proprietary scheme that may have been designed to accommodate particular needs of a growing enterprise. The target 220 may be a standardized database adapted to suit current needs of the enterprise. It may be desired to bring data from the source 210 to the target 220 such that the enterprise may adopt use of the standardized database. Therefore, there may be a data conversion system 200 configured to convert data from the source 210 to the target 220.

The data conversion system 200 may be configured to extract data from the source 210 and convert it from the source scheme to the target scheme. The data conversion system 200 may insert the extracted and converted data into the target 220. Also, a data conversion system 200 may be configured to convert in more than one direction. For example, a source 210 may also be a target 220 and a target may also be a source 210. Thereby, there may be data conversion in more than one direction as data may be extracted from both, converted from both schemes to both schemes, and inserted in both.

Additionally, data conversion may be a single batch process, wherein data is converted only in a single batch sufficient to address the entire need for conversion. Thereafter, an enterprise may cease using a source. Alternatively, data conversion may be a continuing process, whereby data may be converted in real-time or near real-time from one or more sources to one or more targets preferably according to a regular schedule such as every five minutes. Thereby a source 210 and a target 220 may be integrated, wherein data from a source 210 may be continually updated into a target 220. For example, a source 210 may be a repository for a data entry process that may also contain sufficient data to populate a target 220. A second data entry into the target 220 may be automated by integrating data from certain records and fields from the source 210 into the target 220 through a data conversion system. The data conversion system 200 may be portable between different servers, clients, and schemes. Thereby the same data conversion system 200 may be used to perform data conversion for an unlimited number of data conversion needs.

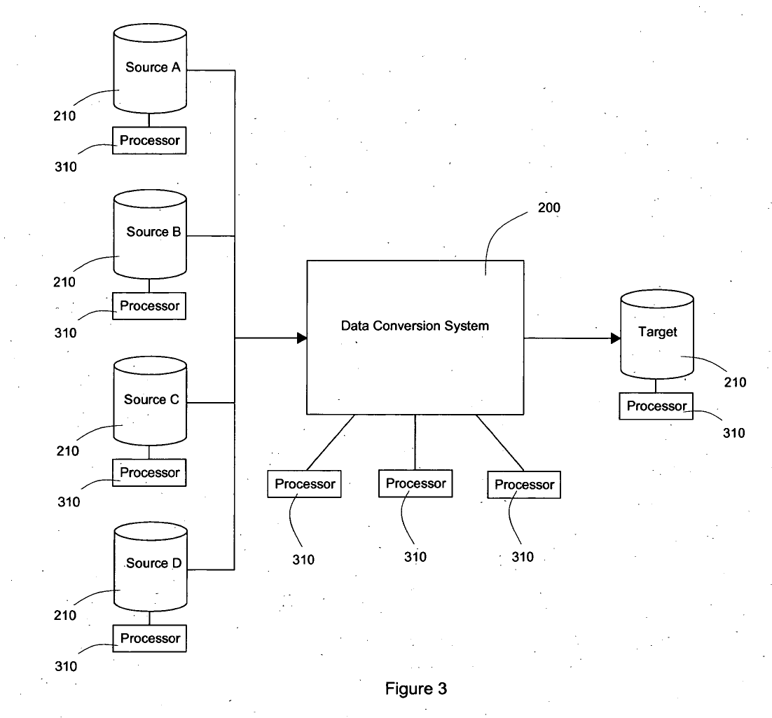

Looking to FIG. 3, there is shown a schematic block diagram illustrating a data conversion system extracting from multiple sources according to one embodiment of the invention. There may be a data conversion system 200 that may be in control of one or more processors 310. These processors 310 may be in one or more devices such as computers belonging to an enterprise. For example, the data conversion system may have access to multiple computers and may have an ability to direct those computers to perform conversion steps. Also there may be a plurality of sources 210 that may have one or more processors 310. Further, there may be a target 220 that may have a processor 310.

In operation, the data conversion system 200 may control one or more processors 310 external to the source(s) 210 and target 220. These processors 310 may be used in parallel to perform a conversion quickly and efficiently. For example, the data conversion system 200 may be coupled to a plurality of processors 310, wherein the data conversion system 200 may divide conversion work into portions that may be independently handled by each processor 310 and then reported back to the data conversion system 200.

The data conversion system 200 may extract source data from the plurality of sources 210 and may convert the source data by using one or more processors 310. In particular, the data conversion system 200 may perform one or more conversion steps using a processor 310 associated with one or more of the plurality of sources 210. Because server processors typically must be relatively powerful, it is preferable to perform as much of a conversion as possible using processors 310 associated with servers 110. Further, wherein a source 210 is a database, it may be preferable to perform some data conversion steps using database management tools of the source(s) 210.

Also, a target 220 may be associated with a server 110 that may have a processor 310. Data conversion steps may be preferably performed using the processor 310 associated with the target 220 where such would provide an advantage. For example, wherein the source(s) 210 may be flat files and a target 220 may be a sophisticated and powerful database, it may be advantageous to insert extracted data from the source(s) 210 into the target 220 and then perform conversion steps utilizing as many data management commands of the target database program as is most efficient.

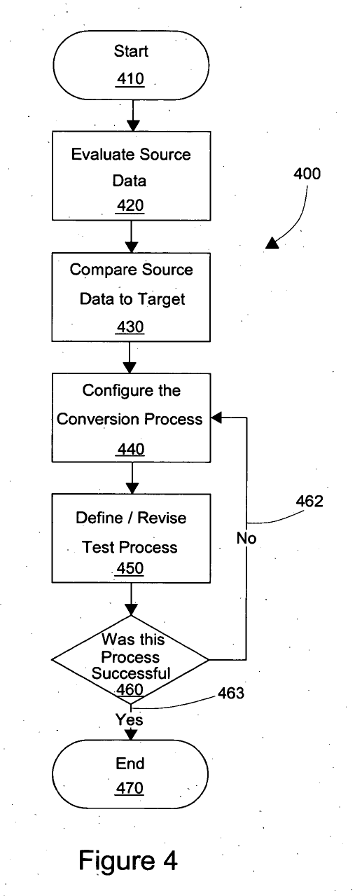

FIG. 4 illustrates a flow chart displaying a data conversion configuration method according to one embodiment of the invention. Source data should be evaluated 420 preferably to determine structure and contents. This may be particularly difficult where source data may be in a nonstandard format or may not be a database. The source data should be examined for patterns, contents, variations on patterns, etc. thereby developing an understanding of how the source data is structured and how it may be extracted and/or used.

The structure and contents of the source data should be compared 430 to the target. Content sufficiency of the source should be established; else additional sources may need to be included. For example, wherein the target may require a list of children of an employee and a source does not include such information, it may be necessary to include a further source having such information. Data structure should be compared to determine what steps may need to be performed to transform/clean the source data sufficiently to properly prepare it for insertion into the target.

The conversion process should be configured 440 according to determined conversion needs. The tools used should be adapted for use with the source and target and prepared to perform the steps needed to convert the data. Then the process should be defined/revised 450 according to the configuration and any previous conversion results.

As the process is carried out, or upon completion, an evaluation should be made 460 as to the success of the conversion process. Where the process successfully completes 463 the goals of the conversion, the conversion is completed and may end 470. Where the process does not successfully complete 462 one or more goals of the conversion, the conversion should return to the configuration step 440 for additional configuration on accordance with the failure to meet one or more goals of the conversion process.

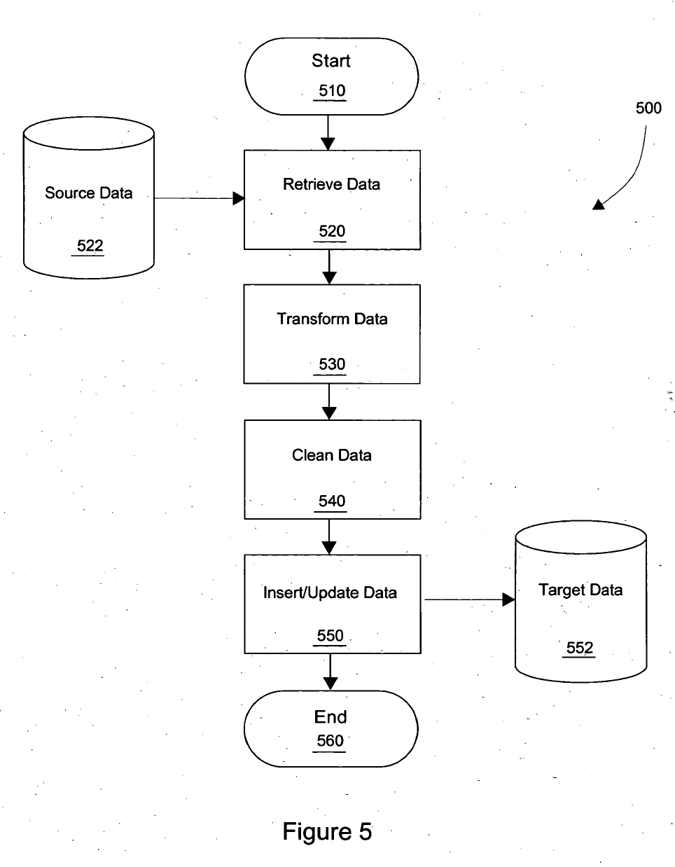

FIG. 5 illustrates a flow chart displaying data conversion according to one embodiment of the invention. Wherein it is desired to convert Source Data 522 to Target Data 552, a data conversion may take place. Source Data 522 may be retrieved 520 for use in the data conversion process. Retrieval 520 of Source Data 522 may be retrieved simply by issuing appropriate database command; or it may be complicated as negotiating streaming of the data from a source and interpreting the data after evaluating its structure and format. The data may then be transformed 530 and/or cleaned 540. Transformation may include but is not limited to data mapping transformations. Cleaning may include but is not limited to formatting data, including formatting data that may not be appropriately formatted for both the source 210 and the target 220. When the data is in proper form it may be inserted/updated as Target Data 552. Insertion may be simple or complicated in ways similar to retrieval 520. Wherein the insertion is complete, the process is finished 560.

Each of the steps may be performed by the same or different modules on the same or different processors. Preferably the data is transformed 530 before it is cleaned 540. Further, wherein the conversion is part of a integration, the steps may be repeated indefinitely to provide real time or near-real time conversion of data.

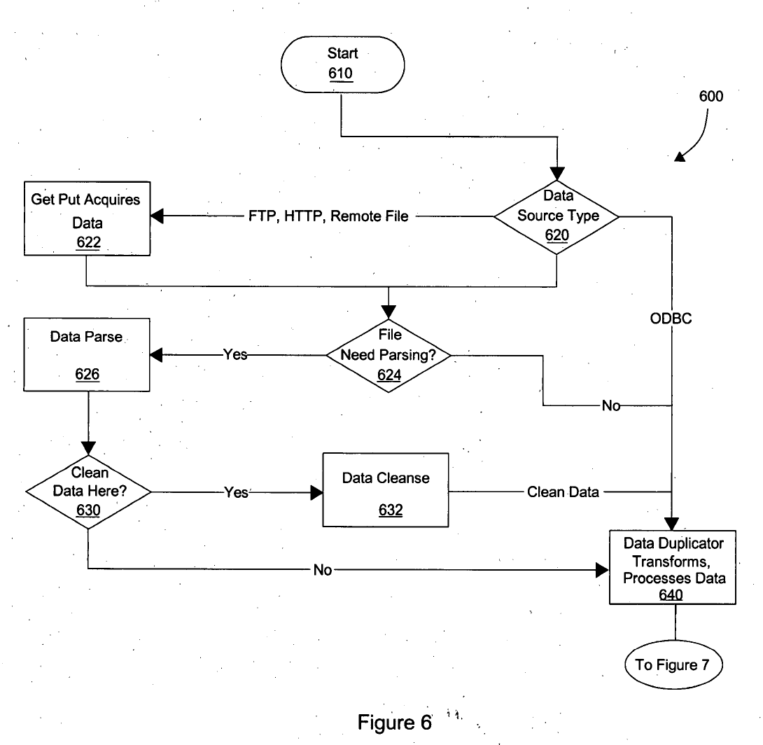

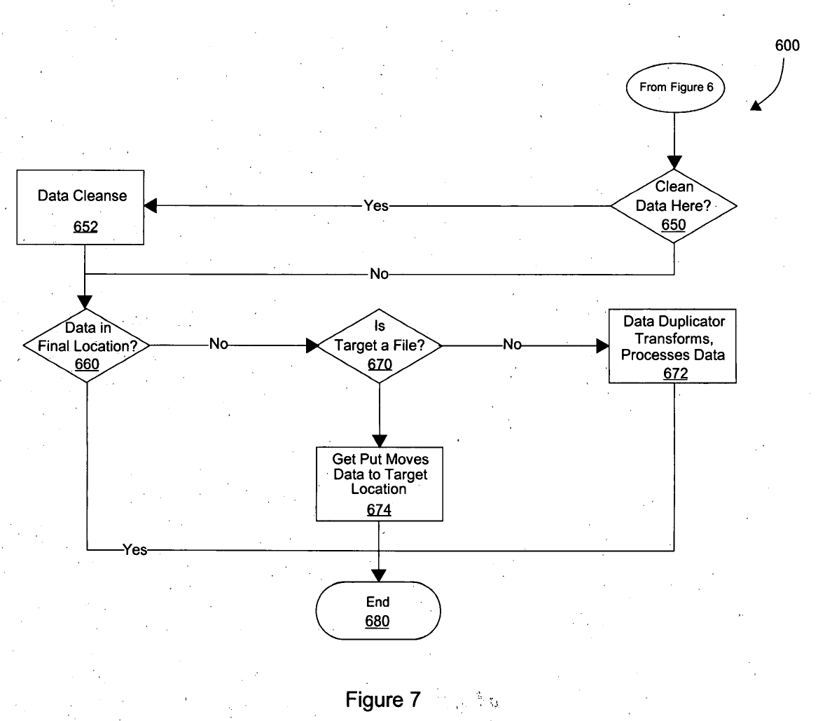

FIGS. 6-7 illustrate a detailed flow chart displaying a data conversion method according to one embodiment of the invention. When beginning 610 data conversion, the data source type should be evaluated 620. Where the data source type requires special access such as where the data source is a remote file and/or best accessible by FTP or HTTP, it is preferred to use a Data Get/Put module to retrieve 622 the data. If the Data Source type is an ODBC (Open Database Connectivity) type source, then it may be directly retrieved and transformed 640.

Data retrieved 622 via a Data Get/Pet module and local file data that is not ODBC should be evaluated for parsing needs 624 and if the data should be parsed then it may be parsed 626 by a Data Parse module. Where the data need not be parsed it may be transformed and processed 640 by a Data Duplicator module. After non-ODBC data is parsed, it should be determined if the data should be cleaned 630. Where the data should be cleaned it may be cleaned 632 by a Data Cleanse module; then it should be transformed and processed 640 by a Data Duplicator module.

Upon completion of transformation and processing 640 the data should be evaluated 650 for any cleansing needs and should be cleaned 652 by a Data Cleanse module should it be determined there be sufficient need. The data should also be evaluated to determine 660 if the data is in its final location (the location where the data is intended to reside as target data). If the data is in its final location then the method may end 680. If the data is determined 660 to not be in its final location then the data should be evaluated 670 as to its status as a file. If the data is a file a Data Get/Put module should move 674 the file to its final location and then the process may end 680. If the data is not a file, the data should be further processed and transformed 672 into its final location, preferably by a Data Duplicator module, wherein the process may end 680.

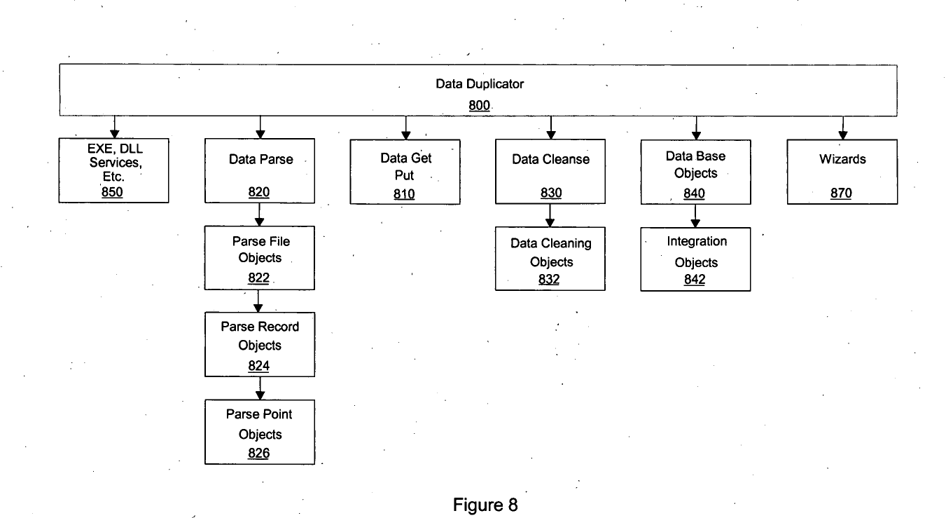

FIG. 8 illustrates a control structure for a data conversion system according to one embodiment of the invention. There is shown a Data Duplicator module 800 that may be configured to call subordinate instruction sets, such as but not limited to Data Get/Put modules 810; Data Parse modules 820; Parse File Objects 822; Parse Record Objects 824; Parse Point Objects 826; Data Cleanse modules 830; Data Cleaning Objects 832; Database Objects 840; Integration Objects 842; executables, DLLs, Services, Scripts, etc. 850 and/or wizards 870. The Data Duplicator module 800 may serve as a backbone for all other data conversion modules, processes, objects, and steps. The Data Duplicator module 800 may manage utilization, control, and flow of one or more steps of a data conversion process.

In operation, a user may configure the Data Duplicator module 800 to call modules, executables, objects, DLLs, worksheets, and/or wizards, etc., according to a hierarchy defining an orderly carrying out of a conversion process. The Data Duplicator module 800 may be configured to allow a user to call subordinate instruction sets during a configuration of the Data Duplicator module 800. For example, an SQL Worksheet may be called by a user to help debug an Integration Object 842 or to determine a optimum command to include in the data conversion process.

Data Get/Put 810 may be used to download/upload data over TCP/IP, or similar, connections. The Data Get/Put module 810 may be configured to pull data over FTP, HTTPS, and/or HTTP connections, thereby permitting access to data that would otherwise not be available over the network. There may be included support for passwords and/or encryption.

There may be wizards 870 associated with and/or integral to one or more modules, such as a Data Duplicator module 800. Wizards 870 may be configured to perform repetitive tasks such as creating and naming Integration Objects 842 in relation to data fields. Wizards 870 may be included and configured to evaluate migration steps and estimate their chance of success. Wizards 870 may be configured to perform common SQL statements such as but not limited to Selects, Counts, and Duplicate Checking on a field. Further, wizards 870 may be configured to provide speed verification of data and/or serve as an ad hoc reporting tool.

A module may be a wizard 870, for example, a Data Cleanse module 830 may be a wizard 870. There may be a wizard 870 configured to build objects for a database 120. There may be a wizard 870 configured to build SQL scripts. There may be a wizard 870 configured to build documentation. There may be a wizard 870 to check field integrity. There may be a wizard 870 to check database connections. There may be a wizard 870 configured to populate portions of a module, such as an Integration Object 842, with metadata. There may be a wizard 870 configured to build SQL for portion(s) of a module, such as an object for a Data Duplicator module 800. Wizards 870 may be toolbar wizards 870 that may affect a whole script or process. Wizards 870 may be popup menu wizards 870 that may be configured to affect a currently selected portion of a module, such as an Integration Object 842 for a Data Duplicator module 800.

For example, a “Build objects for Database” wizard may perform or may allow a user to: select one ore two ODBC compliant databases to read metadata from (including text databases created by Data Parse); supports Insert, Update, and Delete objects; auto-match on table names, or allow the user to match tables as they see fit; allow for Left to right, and/or Right to left objects to be created; auto-match field names, and allow the user to override, or select fields that will be mapped.

Also, for example, a “Builds the Objects” wizard may build field listings from the metadata, and build Selection SQL (if source is an ODBC Compliant DB). Still more, for example, a Build SQL Scripts wizard may step through objects and rebuild an SQL for a Selection SQL (This may be useful if a user adds many joins after the wizard has run.) Still even more, for example, a “Build Documentation” wizard may step through objects loading filed mappings and may save out a CSV file with all the mappings currently in the script and/or process. Also, for example, a Check Fields Integrity wizard may use metadata of a Target database to determine the likelihood of success for each step. Likelihood may be determined by the following Criteria: Green: All Fields in the target database are being assigned data, and the format is compatible (Strings=Strings . . . ); Yellow: All required fields are being assigned data and compatible field types are being assigned (String=Integer); and Red: Required fields are not being populated, or incompatible types are being assigned (Date Time=BLOB). Additionally, for example, a Check Database Connections wizard may connect to a database to make sure a user has a connection. (Useful if a user has not connected from a location before, before using the other wizards). Still also, a Populate with Metadata wizard may read a Database, if possible, and place field names in a Fields Properties for a selected object. (This may eliminate lots of time consuming typing, and the typos that come with it). Still also more, a Build SQL for this object wizard may use Metadata stored in an object to build SQL for selection. This may assume that fields in two properties for left and right database have been aligned so that the first field goes into the first field and so on through all the fields. Extra fields in the source tables may be left out of the Select.

There may also be a documentation generation module, or wizard. The documentation generation wizard may be configured to generate documentation for conversions from machine code. For example, there may be a wizard 870 configured to create a documentation spreadsheet that documents the actual data mapping configured within a Data Duplicator module 800. Advantageously, this documentation spreadsheet tracks the actual data mapping instead of intended data mapping, therefore a user of the spreadsheet may rely on the accuracy thereof. The wizard may read through all the integration objects and thereby write the data mapping document.

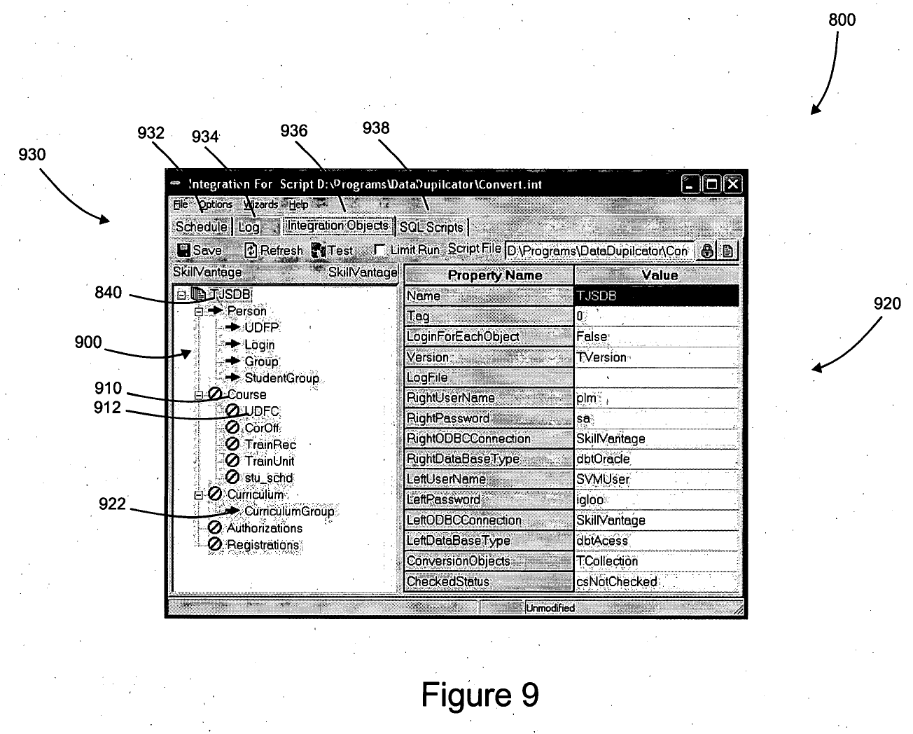

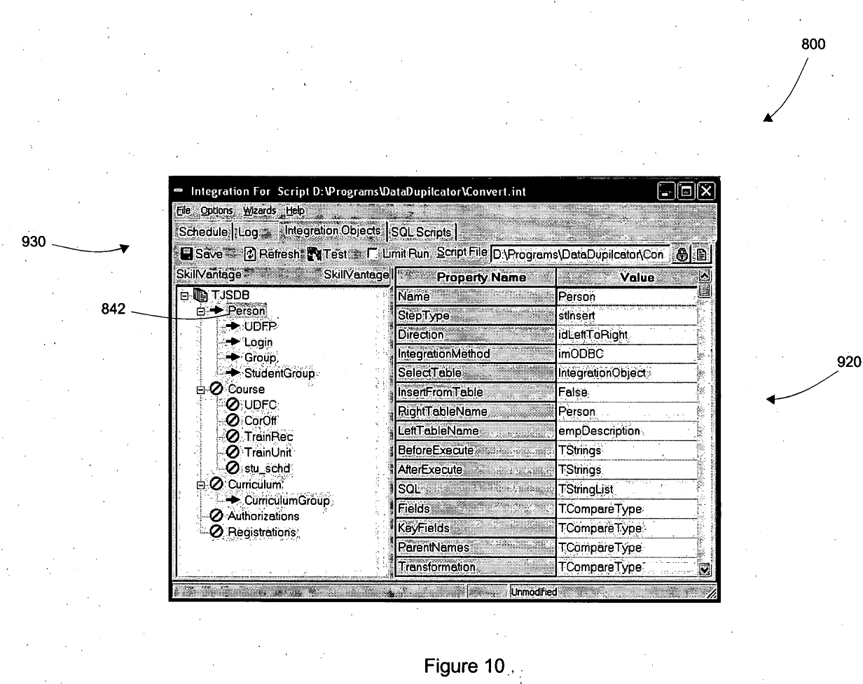

FIGS. 9-10 show an exemplary screenshot of a Data Duplicator module, or data conversion module 800 according to one embodiment of the invention. In particular, FIG. 9 shows a screenshot wherein a database object, or base object 840 is selected and FIG. 10 shows a screenshot wherein an integration object 842 is selected. The Data Duplicator module 800 may be used to manage conversion of data from a source 210 (see FIG. 2) to a target 220 (see FIG. 2). Also, the Data Duplicator module 800 may be used to build, test, and cause to be executed steps of data conversion 200 (see FIG. 2). More, the Data Duplicator module 800 may be written in machine language/binary for the purpose of greatly enhancing speed and efficiency. Additionally, the Data Duplicator module 800 may function as a management module, organizing and directing the steps required to convert data from a source 210 to a target 220.

The Data Duplicator module 800 may create, manage, and control Integration Objects 842, described in more detail later in the specification. There may also be included the ability to call and control other modules, such as Data Get/Put 810 (see FIG. 7), Data Parse 820 (see FIG. 7), and Data Cleanse 830 (see FIG. 7). Further, there may be included the ability to call and control other files including but not limited to file types EXE, DLL, Active X Controls, OCX, Service, Scripts, and ODBC (SQL Server, Oracle, My SQL, Access, stored procedures, macros, other features provided by an ODBC manufacturer, etc.).

Within the Data Duplicator module 800 there may be a hierarchical design 900 that may be graphical and may include drag and drop capabilities. This design may be a tree structure 900 wherein portions, such as objects, such as Integration Objects 842, of the structure may be organized in a sequence. Further, portions of the structure may be interrelated. For example, objects may be related to subordinate/owned/children objects. Thereby objects may be structured into groups and/or families. Subordinate Objects, or Children 912, may depend from Parent Objects 910. Utilization of a Child 912 may depend on utilization of a Parent 910. Further, status, such as but not limited to completion status, of a Parent 910 may depend on status of one or more Children 912.

There may also be debugging tools, including but not limited to log files, step-through capabilities, status indicators, and/or error reports. Error reports and/or log files may include information regarding identification of one or more objects associated with an error, one or more Select SQL statements associated with an error, one or more Target SQL statements associated with an error, and/or any error messages provided by any programs associated in any way with the conversion.

Further, a Data Duplicator module 800, or an associated program, may be configured to graphically select and/or graphically fix errors reported in debugging tools. For example, an error log may include a reference to an object associated with an error. There may also be sufficient information to determine that the error may be corrected by adjusting a property, or properties, of the object. The object may be selected and manipulated from a Data Duplicator module, thereby correcting the property or opening an interface whereby the property may be altered. Further, error stopping may be disabled, thereby permitting conversion to continue despite errors. This may be advantageous where there are relatively few errors. For example where there may be ten million records and only five errors that each only impact a single field in a single record, it may be advantageous to complete conversion and deal with each error individually.

Further, there may be included options to save changes, lose changes, test current migration scheme, limit run process a specified number of records for debugging, open a file, and create a new file. Processes may be identified by version. A conversion process may include any number of process steps. Each step in a conversion may be represented graphically by an object on a tree 900. There may be an unlimited number of steps and/or objects. There may be options permitting pauses or “sleeping” for specified and/or calculated portions of time.

A process may be configured to be compiled into a process DLL. The process DLL may be configured to be called as an external procedure from a database. The process DLL may be configured to accept parameters defining which process or which portion of which process to run. The process DLL may be configured to accept a key by which to filter selects. For example, a trigger on a person table could call an update script that would select only that person from a source database 210 and update information in a target database 220 on another machine.

Within a process, there may be steps capable of performing one or more of the following: imports from text files, calling third party DLLs, calling an MSE engine, launching executables, running an SQL statement, running ODBC commands. SQL statements may include but are not limited to updates, inserts, inserts based on data in a target database. ODBC commands may include but are not limited to selects, transformation tables, code to check for existing records, and/or inserts.

Objects may own as many other objects as needed to form a desired logical structure. Objects may have properties 920; properties 920 may be configurable by a user. For example, the direction an object is to operate may be graphically configurable by right clicking an arrow 922 adjacent to a graphical representation of the object. The arrow 922 may include a drop down menu that may allow selection between right or left thereby determining a direction of operation. There may be a selection to determine and indicate non-operation of the object.

Objects may be configured to allow free form SQL for selects. Objects may also use wizards to build SQL for the conversion. Objects may be configured to Insert, Update, and delete SQL built automatically based on Fields, and settings of the object(s). Also, objects may be configured to join tables to build the result fields needed for a step. More, objects may be configured to use Decode and Case statements to transform fields. Still more, objects may be configured to Insert into tables while selecting keys from another table.

There may be other object properties including but not limited to: name; data type; version; conversion object collection; right/left connection DSN, usernames, passwords, and database types; optional events to be called when a record is processed; integrate data commands; options to return information about the status of query objects; copyright information; customer name; version; passwords; hotkeys; step type; direction; integration method; select table; option to insert from table; right/left table names; execution options before and after object execution; SQL; key fields; parent names; transformations; storemax; maxfield; additional where (may include anything desired to be added to an end of a Where Clause of an SQL statement after an insert or update is created); exclusive key (determines whether SQL in an insert needs to have a Where Clause to insure uniqueness); exclusive uses select table (exclusive key uses data from a select table to insure uniqueness); exclusive table (used by exclusive key to insure vuniqueness); DLL or EXE file; Import Export (Import or Export when dealing with ODBC and text files); text file; field delimiter; record delimiter; checked status (used by a wizard to verify whether or not the associated step has yet been analyzed); and/or sub-objects.

There may be different types of objects. One or more of these objects may be a Database Object 840 for supporting an entire hierarchical tree 900. Another object type may include a version object configured to hold information such as but not limited to version, customer, and password information. Another object type may include an Integration Object 842 configured to perform conversion steps.

Integration Objects 842 may be configured to perform one or more conversion steps. The Integration Object(s) 742 may be configured to be managed by a module, such as but not limited to a Data Duplicator module 800. The Integration Objects 842 may be stored and streamed in binary, thereby providing enhanced speed and efficiency. Integration Objects 842 may own and/or be subordinate to other Integration Objects 842. Integration Objects 842 may be organized into a hierarchical tree structure 900, thereby permitting an ordered process. Integration Objects 842 may be configured to have properties subject to manipulation.

Properties 920 of Integration Objects 842 may be configured to allow manipulation of such properties 920 during use. For example, properties. 920 of Integration Objects 842 may be configured to be manipulated by other Integration Objects 842, or other instruction sets, during use. In another example, properties 920 of Integration Objects 842 may be configured to allow manipulation by a user in real time. In still another example, properties 920 of Integration Objects 842 may be populated by wizards, thereby eliminating typographical errors. In still another additional example, the direction an Integration Object 842 is to operate may be graphically configurable by right clicking an arrow 922 adjacent to a graphical representation of the object. The arrow 922 may be selected to point right or left to determine and indicate direction of operation. There may be a further selection to determine and indicate non-operation of the integration object.

Integration Objects 842 may be configured to end in various ways. One way for an Integration Object 842 to be configured to end may be when the Integration Object 842 has successfully completed itself. Another way may include ending upon error. A still another way may include ending upon error of a subordinate/Child 912; A yet still another way may be to continue upon error and end upon completion of processing source data despite any errors. A still further another way may be to continue upon error of a Child 912 object and end upon completion despite any errors of a Child 912.

Preferably Integration Objects 842 are configured to utilize the computing power of servers 110 and the manipulation power of databases 120 by ordering a Target 220 and/or Source 210 database 120 to perform manipulations on data in furtherance of a conversions process as much as possible. In this way the conversion may be completed in less time and may be simpler.

Also, the work may be spread over several processors 310 and/or databases 120. For example, the entire fleet of computers of an enterprise may be configured to accept orders for processing conversion steps. In this way massive amounts of data may be converted in substantially less time. This may be particularly important wherein a minimum of interruption is required. Where a tremendous conversion would otherwise take two weeks, it may only require one day if parallel processed, thereby allowing a tremendous conversion to be accomplished over a weekend.

Preferably Integration Objects 842 are written in a language such as Delphi that supports a true object model (inheritance, polymorphism, encapsulation, etc.)

Integration Objects 842 may be configured to allow free form SQL for selects. Integration Objects 842 may be configured to Insert, Update, and delete SQL built automatically based on Fields, and settings of the object(s). Also, Integration Objects 842 may be configured to Join tables to build the result fields needed for a step. More, Integration Objects 842 may be configured to use Decode and Case statements to transform fields. Still more, Integration Objects 842 may be configured to Insert into tables while selecting keys from another table. There may be other integration object properties 920 including but not limited to: name; data type; conversion object collection; right/left connection DSN, usernames, passwords, and database types; optional events to be called when a record is processed; integrate data commands; options to return information about the status of query objects; copyright information; customer name; version; passwords; hotkeys; step type; direction; integration method; select table; option to insert from table; right/left table names; execution options before and after object execution; SQL; key fields; parent names; transformations; storemax; maxfield; additional where (may include anything desired to be added to an end of a Where Clause after an insert or update is created); exclusive key (determines whether SQL in an insert needs to have a where clause to insure uniqueness); exclusive uses select table (exclusive key uses data from a select table to insure uniqueness); exclusive table (used by exclusive key to insure uniqueness); DLL or EXE file; Import Export (Import or Export when dealing with ODBC and text files); text file; field delimiter; record delimiter; checked status (used by a wizard to verify whether or not the associated step has yet been analyzed); and/or sub-objects. and that has an object writer and reader that write objects in binary instead of using text to store properties. Thereby objects, and preferably all their children, may be read and written as a block. This may be especially useful and greatly promote efficiency wherein Integration Objects 842 may be numerous and organized into a large hierarchy.

Preferably properties of the Integration Objects 842 may be configured according to the following:

Direction: Direction determines whether or not an object is used. The data selected will be inserted, updated, or deleted, into either a text file or the other database depending on the type. Preferably, source and destination are not both text files.

IdNotUsed: The Object will not be used, nor will it's Children 912 be used.

IdLeftToRight: The Object will be used with “Left” SQL Statements, wherein “Left” refers to a source displayed on the left portion of the screen, that may be the Source and “Right” refers to a source displayed on the right portion of the screen, that may be the Target.

IdToRightToLeft: The Object will retrieve data from the Right Data Source and output data to the Left.

Before Execute: This SQL Statement will be “Run” Before the Object's IntegrateData method is called. If StoreMax is True, and the SQL returns a value, that Value will be preserved in an internal variable Called FMAX.

After Execute: This SQL Statement will be executed after the Object's IntegrateData method is called. If StoreMax is True and the internal variable FMAX is not null, and the SQL has ‘MAXFIELD’ in it, the text MAXFIELD will be replaced with the value stored in the internal variable FMAX. The use of Before and After Execute in this manner allows updating a table of current Maximums. This is important for handling some database schemas, such as those that do not utilize an auto incrementing field for their key.

Insert, Update, Delete: The standard functions of integration should include Inserts, Updates, and Deletes. The Integration Objects may automatically build these statements based on the fields and on other properties.

Insert: Insert is “Run” when (Direction=idRightToLeft and SQL is not null and RightTableName is not null) OR (Direction=idLeftToRight and SQL is not null and LeftTableName is not null). The standard insert Statement will look like: ‘Insert Into’+RightTableName+‘(‘+Fields.Left.CommaText+’) Values (‘Values’)’+Where Clause+AdditionalWhere; The Insert statement for selecting inserts will look like: ‘Insert Into’+RightTableName+‘(‘+Fields.Left.CommaText +’) Select’+Values+‘From’+SelectTable+Where Clause and will be called if the InsertFromTable Property is true.

Right table name is the property “RightTableName”. Fields.Right.CommaText is likewise a property. Values are the Fields. Left.CommaText in this instance. The Where Clause may be generated automatically from the Fey fields, and parent table property.

Update: Update is “Run” when (Direction=idRightToLeft and SQL is not null and RightTableName is not null) OR (Direction=idLeftToRight and SQL is not null and LeftTableName is not null). The standard Update statement will look like this: ‘Update’+RightTableName+‘Set’+Values+WhereClause+AdditionalWhere; Values will be a comma-separated list of “FildName=Value” generated from the Select. WhereClause will be a string with the values “KeyFieldName=Value (And)” generated by selecting from the values from the select based on the key fields.

Delete: Delete is “Run” when (Direction=idRightToLeft and SQL is not null and RightTableName is not null) OR (Direction=idLeftToRight and SQL is not null and LeftTableName is not null). The Standard Delete Statement will look like this: ‘Delete From’+RightTableName+‘Where’+WhereClause+AdditionalWhere; Delete may be not preferred as it will destroy historical data. Instead, if possible, the record should be marked inactive.

Fields: The Fields property is a TCompare object and can hold two lists of field names. These names can be different names, but should correspond to the same data. It is noted that selecting data as the same name as the “target” tables field makes debugging easier. Also, there may be functions like selecting values from another table where names are used across the two databases. Usually the two sides of a TCompare object have the same number of entries, but there may be more in the select (or from side) to use for selection fields since the number of fields processed is determined by the destination (Or To Side)'s count.

Parent Fields: Parent Fields exist to allow selection of data from one Table to insert into another (Like Selecting ID from person to create the Login table).

Key Fields: Key Fields may be used for at least two purposes: First, when Updating or Deleting a Table, the key fields determine what fields are in the where clause in a KeyFieldName=Value(,)) Format. Second, when Inserting, if the key fields are empty “” or are ‘NULL’ they will be populated with numbers from the GetNextID(TableNumber: Integer) function. In databases with auto-incrementing-numbers schemes, these fields can be generated automatically by selection and/or insertion. In other databases, this may require math on a max selected in the before SQL which will be updated by the After SQL.

Transformation Tables: If a field transform can be done with a “Decode” or a “Case” statement in SQL, it is preferred to do so. Since this cannot always be accomplished, there is the transform fields list, which is a tCompare Object, Left, and right. Transformation tables are lists of ThisField.ThisValue=ThatField.ThatValue. The lists will be processed and values checked if a current filed Value combination matches a stored value for the from field list it will be replaced with the value from the to list.

When selecting from a different table, it may be necessary to place the field's name in the “TransformTables as a value. To do this enter Fieldname*Value into both tables in the same numerical location the * will force that text into the output field regardless of the value carried in that field from the select. (example: The Value ID.*.p.ID in the same place in both transform lists will result in the ID field of the insert Query=p.ID. Using this functionality permits having selects going from several tables at once. It is preferred, for purposes of enhancing speed, to perform as many transformations as possible using decode, or case statements in the select SQL. It is preferred that both sides of the Transformations property should have the same number of Entries.

Inserting From a Select. Inserting from a select statement uses the Transforming tables function described above. There are other settings that may need to be set to make this work properly. Insert From a Table should be set to True, Select Table Should be set to: TableName [identifier][,TableName [Identifier]] . . .

Exclusive Tables. Exclusive Tables are often used with Inserting from a select, but not always exclusively. To use an exclusive table, you set the Exclusive Key Property to true, the Exclusive Table should contain the name of a table to be checking for Exclusivity against. Exclusivity will be determined by selecting the Key Fields names from the table that are equal to the values currently selected from the Source Database. (I.E. Select ID from Person Where ID=‘42’ where exclusive table is person, and key fields contains only ID) This will return a record set of 0 rows where the record needs to be inserted, and a record set of greater than 0 rows where the record already exists.

Selecting from a Parent. Selecting from a parent may help in populating relationships like Login relates to Person. ParentNames may be used to retrieve the Parent info. The SelectTable may be set to point to the Parent table.

Where Clauses: Inserts: WhereClauses are generated for the select from values selected from the source table into a string in a “(And) ParentFileName=Value” format.

Updates and Deletes: WhereClauses for Updates and Deletes are generated from values selected from the source table into a string in “(And) KeyFieldName=Value” format.

The following represents an exemplary typical transformation that may be performed by an integration object. There may be a source field that may have the following possible entries: 0—inactive, 1—active, 2—hold, 3—preset, 4—definitional. There may be a target field having the following possible entries: 0—active, 1—inactive, 2—other. The source field in each source record may need to be transformed to the format of the target field for each target record. Therefore the integration object may be called to read the source field and apply transformation rules of mapping 0 to 1, 1 to 0, and 2, 3, and 4 to 2. One skilled in the art would appreciate that as described, integration objects are not limited to this type of transformation, but may perform a large variety of transformations.

The Data Duplicator module 800 may be launched in a stand-alone non-development executable, thereby permitting continued use of a specified scheme without allowing further modification or creation. The Data Duplicator module 800 may be launched from an executable, DLL or via an OCX control or may be loaded as a service, as in Windows 2000, XP, and/or 2003.

The Data Duplicator module 800 may have a tabbed main screen; the tabs 930 may then be subdivided into screen areas. The user may switch between tabs 930 at any time. This ability to switch between tabs 930 advantageously permits alternative views of results of actions and/or decisions made while using the Data Duplicator module 800. The tabs/screen structure may be as follows:

Schedule Tab 932

Automated integration events may be scheduled. There may be an identification label, a determined launch time (time of day, day, days, date, dates, etc.), an object to launch, and/or a script to run. Multiple automated integration events may be managed by adding and/or deleting events from a scheduler. Further, properties of automated integration events may be modified. It may be that an event may be disabled without deleting by assigning NULL to the launch time.

Log Tab 934

A log screen may display a start time, stop time, and/or messages generated by the objects if the objects encounter any errors with a process or script. It is preferred that there be a first line comprising many asterisks, thereby setting apart an entire section of log information. There may also be identifying information on the first line, such as a time and date an error occurred and text of an error message. Preferably, there will be a third line starting a paragraph, wherein the paragraph may indicate whether a LeftTempQuery is active and what a LeftTempQuery includes. Also, there may be a next paragraph indicating whether a RightTempQuery is active and what a RightTempQuery includes. There may be further paragraphs indicating similar or identical information regarding LeftQuery, LeftQuery SQL, RightQuery, and/or RightQuery SQL. The log screen may be populated by testing a process or script. For example, a user may select a “test” button configured to step through a process or script. Upon selection of the test button, the log screen may automatically activate and populate with any errors encountered during a test of the process or script.

In operation, a user viewing a log file displayed when the Log tab 934 is active may be assisted in discovering/determining/solving problems. For example, a user may spot an SQL error by viewing displayed SQL. A user unable to determine if the SQL is a source of error may choose to copy the SQL into an SQL worksheet to see if the SQL will run without error. In another example, a user may isolate portions of SQL that may not be functioning correctly and may use them individually in an SQL worksheet to determine if there are any inconsistencies. For example, where an error regards an SQL insert statement, a user may isolate the associated select to determine if values being selected are of the correct type (including size) to be inserted.

Integration Objects Tab 936

This tab may include a tree view 900 of a process. The tree view 900 of the process may include selectable objects and may graphically show relationships between objects. Further, one or more properties 920 of each object may be graphically shown in the tree view 900.

It may be that objects may be added, deleted, altered in this view. There may be a list of object properties 920 for a selected object. Properties 920 of an object may be alterable in this view. There may be one or more options to save a process, test a process, and/or refresh a process. The tree view 900 may be graphically alterable, such as with drag and drop functionality. Properties 920 of objects may be graphically alterable in the tree view 900, such as with toggling options, such as toggling process direction 922.

SOL Scripts Tab 938.

In this tab there may be included SQL that may be used to select data from a source database if the source database is an ODBC database. There may be triggers in the SQL Scripts tab 938. Triggers may be used to track when a record is inserted, updated, or deleted.

In operation of a Data Duplicator module 800, a user may configure objects and other entities controllable and/or callable by the Data Duplicator module 800. Preferably, configuration will be directed to conversion of at least one set of data from a Source 210 to a Target 220. The user may test configurations, view partial or complete results of use of at least a portion of a configuration, develop objects, attach objects, organize objects, relate objects, alter object properties, record results, evaluate configurations, and perform data conversion. Information relating to data conversion may be preferably stored in text files and/or an industry standard file such as CSV.

Preferably, when configuring the Data Duplicator module 800 for data conversion, a configuring user will conform the structure of the tree view of the graphically configurable hierarchy of object to the structure of the target database 220. Therefore business rules of the target database may be visually present in the object structure. Advantageously, it is clear where data is going (instead of only knowing where it may be coming from). Further, in this way functionality is documented visually in the hierarchy and is updated simultaneous with creation. Therefore documentation of functionality is integral to the process and cannot be separated therefrom.

When converting, the Data Duplicator module 800 may be configured to read each file only once, stepping through each of the objects, preferably disposed in a hierarchy 900. Thereby conversion speed and efficiency may be enhanced. Further, the Data Duplicator module 800 may be configured to convert data in preparation for population of multiple Targets 220 in a single pass of the program through the file.

Also, the Data Duplicator module 800 may be configured to share processes with multiple machines. For example, a Data Duplicator module 800 may be configured to instruct multiple machines to simultaneously perform conversion steps. Preferably a Data Duplicator module would assign portions of work for each machine, such as assigning a non-overlapping record range to each machine. A Data Duplicator module 800 may manage each machine and utilize results obtained from each machine, thereby greatly enhancing conversion speeds. Also, a Data Duplicator module 800 may be configured to run in various modes, including but not limited to batch, real-time, and/or near-real-time.

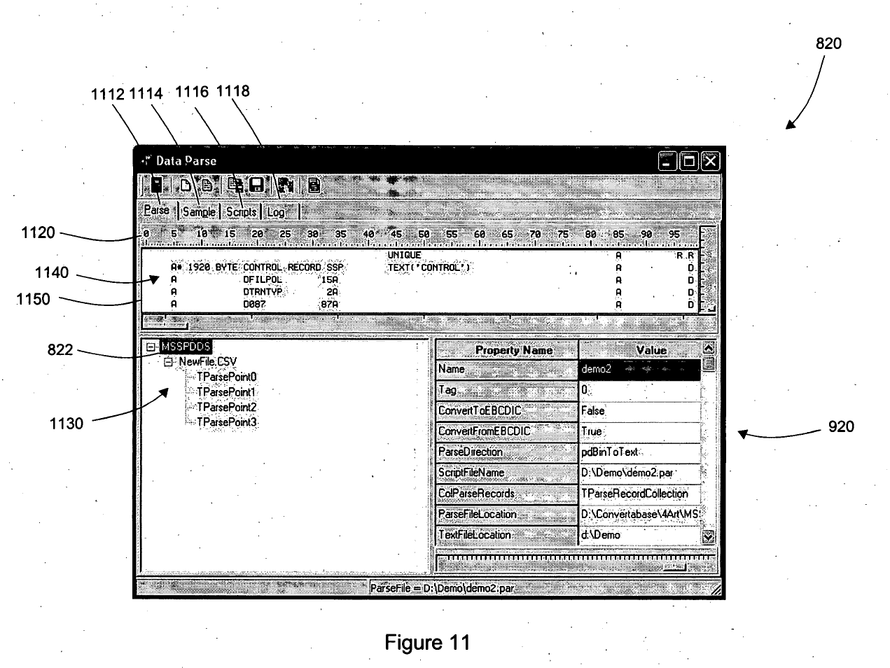

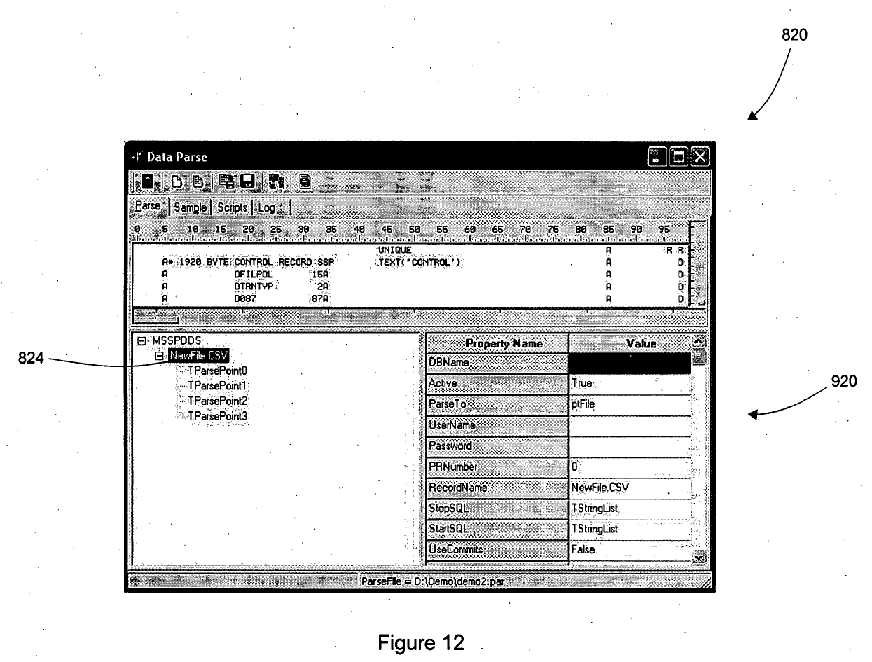

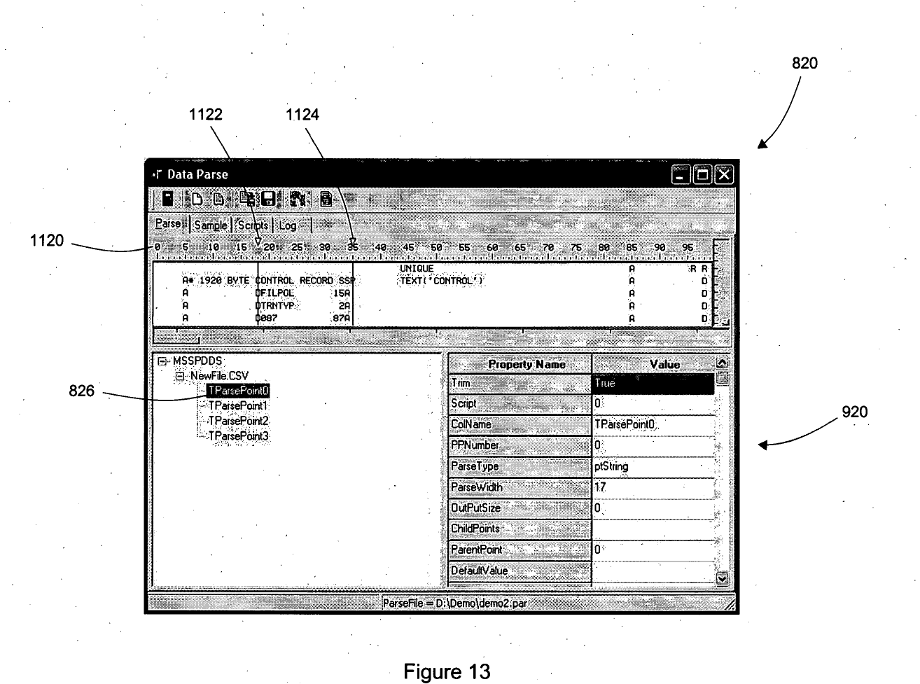

FIGS. 11-13 shows an exemplary screenshot of a Data Parse module 820 according to one embodiment of the invention. FIG. 11 illustrates a Parse File Object 822 selected; FIG. 12 illustrates a Parse Record Object 824 selected; FIG. 13 illustrates a Parse Point Object 826 selected.

Data Parse 820 may be used to parse flat files such as CSV, Cobol, RPG II, RPG III, Fixed Length, and Character Delimited files. The Data Parse module 820 may be coded in machine code/binary so it is not interpreted. Advantageously, this permits rapid loading of the module and processing of the instructions thereof.

Further, since the Data Parse module 820 may be independent of other modules, an operator may be preparing/using Data Parse 820 while another operator simultaneously performs other functions with other modules. Still further, the Data Parse module 820 uses user defined parse point objects that may be configured using the graphical user interface. Also, there may be a visually configurable record size, permitting a user to adjust a record size and see record and field patterns displayed visually, thereby permitting a user to quickly determine the appropriate record size and get an understanding of the structure. The Data Parse module 820 may use a C-style pointer and avoid using any API calls, thereby permitting a theoretical maximum record size of approximately 4 Terabytes. Also, the Data Parse module 820 may be configured to ignore the function of any and all control characters, such as carriage returns, that may interfere with proper parsing of the flat file. Control characters may still be shown visually. Further, there may be supported single pass parsing of a single file into multiple target files. Still further, Data Parse 820 may be configured such that relationships between such files can be maintained.

Additionally, a Data Parse module 820 may be configured to create key fields at run-time. For example, in database containing employees that have children, there may be a different number of children for each employee, thereby requiring the generation of unique key fields to assign to the employee for association of an unknown number of children. In one embodiment this may be accomplished by assigning a key field number to the record according to a record number. For example, wherein the record needing a unique key is the 476^{th} record to be processed by the Data Parse module 820, a unique key of 476 may be assigned during run-time. Further, multi-field and/or complex keys may also be assigned.

The Data Parse module 820 may have a tabbed main screen; the tabs 930 may then be subdivided into screen areas. The user may switch between tabs at any time. This advantageously permits alternative views of results of actions and/or decisions made while using the Data Parse module 820. The tabs/Screen structure may be as follows:

Parse Tab 1112:

Top ½ of the screen (Adjustable) may be a control that has a ruler 1120 across it's top, an area that will display data from a file on disk, and can show stop 1122 and start points 1124 for a Selection. This portion of the screen may be scrollable in that any portion of the file to be parsed may be displayed thereon. The Lower Right ¼ (Adjustable) of the screen may have a Tree view structure 1130 on it. The Levels of the tree view may tell what kind of object it contains. The first level may be the Source file and holds the object that has the source file definition in it. The second level may hold output file definitions. The third level may hold individual parse point information. The Lower Left ¼ may have the properties 920 of the selected item in the tree view displayed.

Sample Tab 1114:

This screen may be used to display the parsed information for the records currently displayed in the control at the top of the Parse screen.

Scripts Tab 1116:

The top control may be a drop down list or Scripts already added to the Script. This control may be preceded and followed by buttons that allow the user to add, Remove, Test and/or look at Scripts on the hard disk. The middle area may be filled with the source code for a Script. The bottom area may contain output from the script.

Log Tab 1118:

Log may contain the information about the test run, including any errors that were encountered. when a Parse File Object 822 may be called to parse a file, it may start with the file, read in the first record, and pass the first record to the first parse Record Object 824, which may call the first parse point. The parse Record Object 824 may continue calling parse points, or Parse Point Objects 826 until all have been called. When control may return to the Parse File Object 822, the Parse File Object 822 may call the next parse Record Object 824 to act on the same line until all parse records have been called. Then the Parse File Object 822 may read the next line and start calling parse records, or parse Record Objects 824 again. Thereby the lines may be parsed to any number of records. Therefore a single line may be parsed into several different records. A database may be structured thereby from a flat file.

The Parse Point Objects 826 may include properties that may be set by the user, such as the following properties: name, active status, username, password, parse record number, write instructions, record name, use commits, FADOQuery, FADOConnection, instructions such as SQL instructions to run before or after running against a database, event to have called on Error, event to call if assigned to report status of the parse process, start position, parse width, trim, output field, auto increment field, new line if not null, parse, type (string, currency, integer), parent point, default values, and associated script(s). Preferably the parse point objects are named with relation to the type of data to be parsed therefrom. For example, a Parse Point Object 826 defined by starting character 47 and ending character 103 that contains customer account numbers may be named “CustAcctNo.” The user may define any number of Parse Point Objects 826, permitting parsing of any portion of the flat file, up to and including the entire contents thereof. The Parse Point Objects 826 may then be used to extract the contents of the flat

In operation, a user may load a file, such as a flat file, into a Data Parse module 820. A portion of the file may be displayed visually in a window, preferably in several consecutive rows 1140 of any number of characters, and preferably more than about one hundred characters. A record size, determining after how many characters to start a new line or record, may be adjusted to a known record size or may be adjusted incrementally. Where a record size is unknown, the user may incrementally adjust the record size and watch the record display window 1150 for patterns to develop. As patterns develop the user may be able to quickly and conveniently discover the record size and may also discover other details regarding the scheme of data storage.

Having properly configured a record size for the flat file, the user may then evaluate the file and adjust the viewable configuration to account for common features of flat files such as record data padding. For example, the user may define an offset to crop padded data by setting a character number as the first displayable character number, thereby cropping any number of irrelevant characters.

Once satisfied with the: configuration of the view window 1150, the user may create parse point objects 826 by graphically selecting character sets in a record and defining them as boundaries 1122 and 1124 of parse point objects 826. A parse point object 826 may specify a piece of a file to be extracted, processed, filtered, etc. Parse points 826 may be organized/held by a parse record 824 that may call the parse points 826, preferably in the order they have been organized, preferably in output order, not in read order. Parse records 824 may write out to files and/or to databases.

Parse records 824 may be held by a Parse File Object, or Parse Source Object 822, which may be the root object for a parsing process. For example, file into another file, such as a standardized database file, or such as a Comma Separated Values (CSV) file.

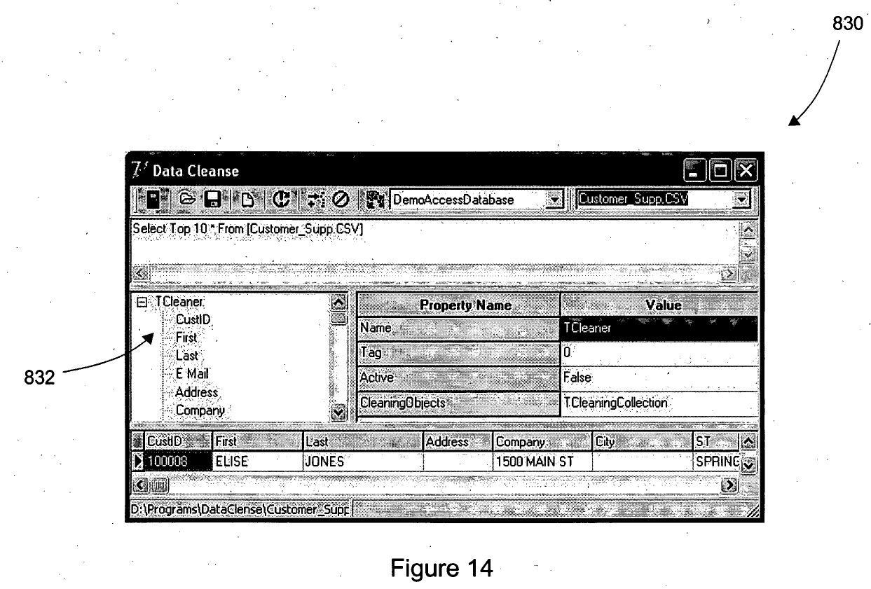

FIG. 14 shows an exemplary screenshot of a Data Cleanse module 830 according to one embodiment of the invention. Data Cleanse 830 may be used to clean/condition data for convenient use by a Target 220 (see FIG. 2). The Data Cleanse module 830 may be programmed in machine code/binary, thereby not being interpreted and thus making the module run quickly and efficiently. Further, there may be included standardized formatting routines. There may also be field masking and/or date conversion. There may be included support for complex scripts, such as those with Python. The data may be organized by field type and the field types may then also define cleansing objects 832 that may be named in relation to the fields. For example, a field named CustID may be associated with a cleanse object 832 named CustID. The cleanse objects 832 may include properties 920 such as active status, field number, field name, field type, field size, in mask, out mask, default value, script. For example, wherein the active status of a particular cleanse object 832 may be set to “False,” the Data Cleanse module 830 may not perform any transformations through the particular cleanse object 832 on any data contained in the field named in the Field Name property.

In operation, a file, preferably a hierarchical database file of a standardized format such as CSV, may be read into the Data Cleanse module 830. A Data Cleanse module 830 may be called by another module, such as but not limited to a Data Duplicator module 800. A Data Cleanse module 830 may be called multiple times during varying steps of a data conversion process. A Data Cleanse module 830 may determine fields having names and other properties of the fields and may create data cleanse objects 832 associated with the determined fields. A user may then adjust properties 920 of the data cleanse objects 832. Such adjustment may be directed to modify data contained in fields for better compliance with a target 220. For example, date data may be conditioned to be in the same format as the date data in the target 220 (i.e. changing dates in a format of DD/MM/YY to MM/DD/YYYY) Data maybe forced to comply with format requirements of a target database, such as but not limited to integers, real numbers, strings, string requirements, currency, date, time, date and time, and/or custom formats. Padding may be added or truncated based on specified parameters. Duplicate fields may be eliminated. Data may be checked for validity. Therefore, data may be more correctly integrated into a target 220.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the description details functions of particular modules, it is understood that functions of modules may overlap among modules. Therefore a function may be carried out over several modules or may be duplicated by more than one module.

Additionally, although the figures illustrate a particular process, it is understood that there may be substantial variations on the process so described. For example, the order may be changed and still fall within the scope of the claims. Also, there may be additional steps without departing from the scope of the claims. Still more, steps may be combined or removed without departing from the scope of the claims.

It is also envisioned that there may be great variety in the visual interface of modules. For example, the hierarchical structure of the conversion process may be displayed as a flow chart instead of a tree. The objects may appear as pictures instead of words. While the direction of an object is described as being shown graphically, direction may be shown textually. Other properties of an object may be shown graphically.

It is expected that there could be numerous variations of the design of this invention. An example is that there may be an unlimited number of colors and shapes associated with the various modules. The graphical interface(s) of each module may be displayed in any known way, such as but not limited to monitors, prints, electrical signals, etc.

Finally, it is envisioned that the components of the embodiments of the invention may be constructed of a variety of components. There may be a single or multiple executables. There may be multiple file types. There may be portions configured with hardware. There may be multiple portions spread across multiple computing devices. Modules may be intentionally partially disabled.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A data conversion system for applying source data from a data source to a data target in a computing environment, comprising:
an extraction module, configured to extract source data from the data source, thereby forming extracted data; and
a conversion module, stored and streamed in machine language, and configured to utilize the extracted data and perform a data conversion process upon the extracted data, thereby forming converted data that is adapted to the data target.

2. The data conversion system of claim 1, wherein conversion module displays a data conversion configuration that is graphically configurable by a user by user arrangement of representations of conversion steps.

3. The data conversion system of claim 2, wherein the conversion module comprises:
a plurality of integration objects configured to perform conversion steps;
a version object configured to store information regarding a conversion; and
a base module configured to facilitate control of the integration objects and to store information regarding the data source and data target.

4. The data conversion system of claim 3, wherein the plurality of integration objects are organized subordinate to the base module in a drag and drop hierarchical structure defining an order of execution.

5. The data conversion system of claim 3, wherein a first integration object may be controlled by a second integration object during a run time.

6. The data conversion system of claim 3, wherein a property of a first integration object is adjustable by a second integration object during a run time.

7. The data conversion system of claim 1, further comprising a documentation generation module configured to generate documentation describing a configuration of the conversion module by reading through conversion steps as defined in the conversion module and writing a data mapping document.

8. The data conversion system of claim 1, wherein the conversion module comprising a visual output module configured to create a visually organized output from a module selected from the group consisting of extraction module and conversion module.

9. The data conversion system of claim 1, wherein the conversion module comprises an organizational display configured to display a current organization of conversion steps.

10. The data conversion system of claim 1, wherein the extraction module makes no API calls.

11. The data conversion system of claim 1, wherein the extraction module includes a plurality of parse objects that are called to extract portions of a record wherein a single record may be parsed into several sets of extraction data in a single pass.

12. The data conversion system of claim 1, wherein the extraction module includes a data display area that displays a consecutive character set of each of a plurality of lines of data according to an adjustable record length.

13. The data conversion system of claim 1, wherein the extraction module comprises parse objects that are created by clicking and dragging portions of a record in a data display window.

14. The data conversion system of claim 1, wherein the extraction module may create key fields as needed at a run time.

15. The data conversion system of claim 4, wherein a first integration object may be controlled by a second integration object during a run time.

16. The data conversion system of claim 15, wherein a property of a third integration object is adjustable by a fourth integration object during a run time.

17. The data conversion system of claim 16, wherein the conversion module comprises a visual output module configured to create a visually organized output from a module selected from the group consisting of extraction module and conversion module.

18. The data conversion system of claim 17, wherein the conversion module further comprises an organizational display configured to display a current organization of the plurality of integration objects.

19. The data conversion system of claim 2, wherein the conversion module further comprising a visual output module configured to create a visually organized output from a module selected from the group consisting of extraction module and conversion module.

20. The data conversion system of claim 19, wherein the conversion module further comprises an organizational display configured to display a current organization of conversion steps.

21. The data conversion system of claim 20, wherein the conversion module further comprises:
a plurality of integration objects configured to perform conversion steps;
a version object configured to store information regarding a conversion; and
a base module configured to facilitate control of the integration objects and to store information regarding the data source and data target.

22. The data conversion system of claim 21, wherein the plurality of integration objects are organized subordinate to the base module in a drag and drop hierarchical structure defining an order of execution.

23. The data conversion system of claim 22, wherein a first integration object may be controlled by a second integration object during a run time.

24. The data conversion system of claim 23, wherein a property of a third integration object is adjustable by a fourth integration object during a run time.

25. The data conversion system of claim 24, wherein the extraction module makes no API calls, may parse a single record into several sets of extraction data in a single pass, may create key fields as needed at a run time, and comprises:
a data display area that displays a consecutive character set of each of a plurality of lines of data according to an adjustable record length; and
a plurality of parse objects that are created by clicking and dragging portions of a record in a data display window.

26. The data conversion system of claim 8, wherein the conversion module comprises an organizational display configured to display a current organization of conversion steps.

27. The data conversion system of claim 10, wherein the extraction module further comprises a plurality of parse objects that are called to extract portions of a record wherein a single record may be parsed into several sets of extraction data in a single pass.

28. The data conversion system of claim 27, wherein the extraction module further comprises a data display area that displays a consecutive character set of each of a plurality of lines of data according to an adjustable record length.

29. The data conversion system of claim 28, wherein the extraction module comprises parse objects that are created by clicking and dragging portions of a record in a data display window.

30. The data conversion system of claim 29, wherein the extraction module may create key fields as needed at a run time.
